(19) United States
(12) Patent Application Publication
(10) Pub. No.: US 2005/0241316 A1
(43) Pub. Date: Nov. 3, 2005

(54) Uniform effusion cooling method for a can combustion chamber

(75) Inventors: Ly D. Nguyen, Phoenix, AZ (US); Stony Kujala, Tempe, AZ (US); David G. Walhood, Scottsdale, AZ (US); Ian L. Critchley, Phoenix, AZ (US); Gregory O. Woodcock, Mesa, AZ (US); Jurgen Schumacher, Phoenix, AZ (US)

Correspondence Address: Honeywell International, Inc.;Law Dept. AB2, P.O. Box 2245, Morristown, NJ, 07962-9806, US

(73) Assignee: Honeywell International Inc., Morristown, NJ (US)

(21) Appl. No.: 10/835,169

(22) Filed: Apr. 28, 2004

(51) Int. Cl. F02C 3/14

(52) U.S. Cl. 60/772; 60/722

(57) ABSTRACT

A dome for a combustion chamber may have a plurality of effusion holes therein to provide efficient cooling while preventing carbon formation on the dome and chamber walls of the combustion chamber. Conventional dome cooling designs, using dome louvers, for example, may become corroded and/or may allow for ingestion of carbon particles that may build up and eventually separate from the dome. Furthermore, the dome cooling design of the present invention allows for the use of a lower profile dome as compared with conventional domes, thereby maximizing liner volume in the constrained combustion envelope while reducing combustor case weight. Additionally, the dome effusion cooling design of the present invention requires the use of less thermal barrier coating, as compared to conventional designs, in order to minimize thermal variation within the dome and between the dome and the combustor wall. A method for uniformly cooling a dome of a combustion chamber of an engine is also disclosed.

This invention was made with Government support under contract number N00019-02-C-3002, awarded by the U.S. Navy. The Government has certain rights in this invention.

### BACKGROUND OF THE INVENTION

The present invention generally relates to a combustion chamber and more specifically, to a can combustion chamber having a uniform effusion cooling method built therein.

Referring to FIG. 1, there is shown a longitudinal sectional view and an end view of a conventional can combustion chamber 10 that has a cylindrical shape with one open end 12. A thin sheet metal may usually be used to fabricate the chamber wall 14 through a forming process. The chamber wall 14 and dome 16 may typically be cooled by multiple louvers 18, 18a and feeder holes 20. Louvers 18a may be attached by welding or a brazing process. Louvers 18, 18a create a gaseous film along the chamber wall 14 and dome 16. This gaseous film helps cool combustion chamber 10 and helps prevent the formation of carbon.

This classical method for cooling combustion chamber 10 is adequate only for low cycle and low performance engines. Such a method may not be effective in terms of combustion life, cooling efficiency, elimination of carbon build up, maintaining a lower and more uniform temperature, and reducing manufacturing complexity for higher performance engines, such as those used in various Joint Strike Fighter (JSF) aircraft.

Due to non-uniform cooling from conventional louvers 18, 18a, the temperature distribution of the dome 16 and of the chamber walls 14 vary, causing thermal stress and therefore reducing the life of the part. Also, with extended operation, the louvers 18a can deteriorate due to carbon formation and variations in the temperature of the dome 16.

U.S. Pat. No. 6,427,446 discloses an effusion cooling method for the liner walls of a can-annular combustor that has a premixing chamber. The method disclosed in the '446 patent uses a dome plate containing multiple rows of angled film cooling holes, angled in a tangential direction, cold side to hot side, to impart swirl into the airflow. The dome serves as a regulator for controlling the amount of air entering the combustor. This conventional system requires a premixing chamber, into which the film cooling holes may be cut, in order to impart swirl into the airflow before it enters the combustion chamber. This cooling method does not address either cooling the dome 16 or reducing carbon formation.

U.S. Pat. No. 6,546,731 discloses an effusion cooling method using double walls over the entire length of the combustion liner. The outer wall has a plurality of holes therethrough to provide normal impingement to the inner wall to provide cooling through convection. The inner wall also has effusion holes, whereby air can effuse into the combustion chamber. This method requires a double wall system, which may add manufacturing complexity and weight to the engine design.

Accordingly, there is a need for an improved combustion chamber utilizing an improved uniform effusion cooling method, whereby cooling efficiency is maximized while eliminating carbon build up, maintaining a lower and more uniform temperature, and reducing manufacturing complexity of high performance engines.

### SUMMARY OF THE INVENTION

In one aspect of the present invention, a dome of a combustion chamber of an engine comprises a dome wall having a plurality of effusion holes passing through the dome wall, the effusion holes being uniformly spaced on the surface of the dome, wherein the effusion holes have a density of from about 10 to about 100 holes per square inch of the surface of the dome.

In another aspect of the present invention, a dome for a combustion chamber of an engine comprises a dome wall having a plurality of effusion holes passing through the dome, the effusion holes being uniformly spaced on a surface of the dome with a hole density of from about 10 to about 100 holes per square inch, wherein the effusion holes have a diameter from about 0.010 to about 0.040 inch; a center axis of each the plurality of effusion holes forms a first angle with a tangent to the surface of the dome of from about 7 to about 90 degrees; a centerline of the combustion chamber forms a second angle with the center axis of each of the plurality of effusion holes of from about 0 to about 180 degrees; and a ratio of the length of the combustion chamber to the diameter of the dome is greater than or equal to about 2.

In yet another aspect of the present invention, a combustion chamber for an engine comprises a dome; a can combustion liner having a first end attached to a scroll assembly, and a second end covered by the dome; and a plurality of effusion holes passing through the dome, the effusion holes being uniformly spaced on a surface of the dome with a density of from about 10 to about 100 holes per square inch of the surface of the dome.

In a further aspect of the present invention, a combustion chamber for an aircraft engine comprises a dome; a can combustion liner having a first end attached to a scroll and a second end covered by the dome; and a dome wall having a plurality of effusion holes passing through the dome wall, the effusion holes being uniformly spaced on the dome with a density from about 10 to about 100 holes per square inch of the surface of the dome, wherein the each of the plurality of effusion holes has a diameter from about 0.010 to about 0.040 inch; a center axis of each the plurality of effusion holes forms a first angle, θ, with the surface of the chamber dome of from about 7 to about 90 degrees; a centerline of the combustion chamber forms a second angle, β, with the center axis of each of the plurality of effusion holes of from about 0 to about 180 degrees; and a ratio of the length of the combustion chamber to the diameter of the dome is greater than or equal to about 2.

In another aspect of the present invention, a high performance gas turbine engine comprises a combustion chamber; a dome attached to a first end of the combustion chamber; a scroll assembly attached to a second end of the combustion chamber; and a plurality of effusion holes passing through the dome, the effusion holes being uniformly spaced about the dome with a hole density from about 10 to about 100 holes per square inch, wherein each of the effusion holes has a diameter from about 0.010 to about 0.040 inch; a center axis of each the plurality of effusion holes forms a first angle with the surface of the chamber dome of from about 7 to about 90 degrees; a centerline of the combustion chamber forms a second angle with the center axis of each of the plurality of effusion holes of from about 0 to about 180 degrees; and a ratio of the length of the combustion chamber to the diameter of the dome is greater than or equal to about 2.

In still a further aspect of the present invention, a method for uniformly cooling a dome of a combustion chamber of an engine, comprises a) providing the dome, the dome including a dome wall having a plurality of effusion holes therethrough, the effusion holes being uniformly spaced on a surface of the dome with a hole density from about 10 to about 100 holes per square inch; and b) passing an airflow through the effusion holes into the combustion chamber during operation of the engine.

These and other features, aspects and advantages of the present invention will become better understood with reference to the following drawings, description and claims.

### BRIEF DESCRIPTION OF THE DRAWINGS

FIG. 1 is a longitudinal sectional view and an end view of a conventional can combustion chamber, according to the prior art;

FIG. 2 is a cross-sectional view of the power section of an engine having a dome and combustion chamber cooling design according to the present invention;

FIG. 3 is a partially cut-away perspective view of a combustion chamber and scroll assembly having the dome and combustion chamber cooling design according to the present invention;

FIG. 4 is a perspective view of the dome of a dome and combustion chamber cooling design according to the present invention;

FIG. 5A is a close-up view of a section of the dome of FIG. 4;

FIG. 5B is an enlarged view of the surface of the dome shown in FIG. 5A;

FIG. 6 shows thermal paint results for a dome having a conventional dome and combustion chamber cooling design according to the prior art; and

FIG. 7 shows thermal paint results for the dome of FIG. 4 according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the combustion chamber of the present invention may be used in any number of applications where conventional can combustors may be used. These applications include gas turbine engines for aircraft and land-based vehicles, as well as in engines used in generator equipment. The present invention provides a dome for a can combustor having a plurality of effusion holes therein to provide efficient cooling while preventing carbon formation.

In contrast to the present invention, conventional dome cooling designs of the prior art, using dome louvers, for example, may become corroded and/or may allow for ingestion of carbon particles that may build up and eventually separate from the dome. Furthermore, the dome cooling design of the present invention allows for the use of a low profile dome as compared with conventional domes, thereby maximizing liner volume in the constrained combustion envelope while reducing combustor case weight. Additionally, the dome effusion cooling design of the present invention requires the use of minimal or no thermal barrier coating, as compared to conventional designs, in order to minimize thermal variation within the dome and between the dome and the combustor wall.

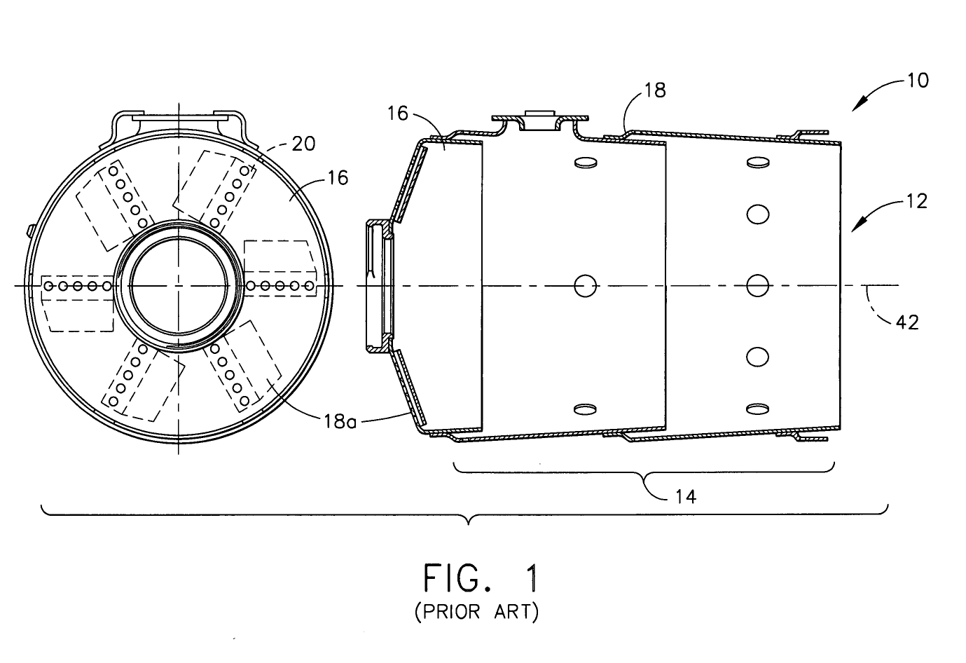

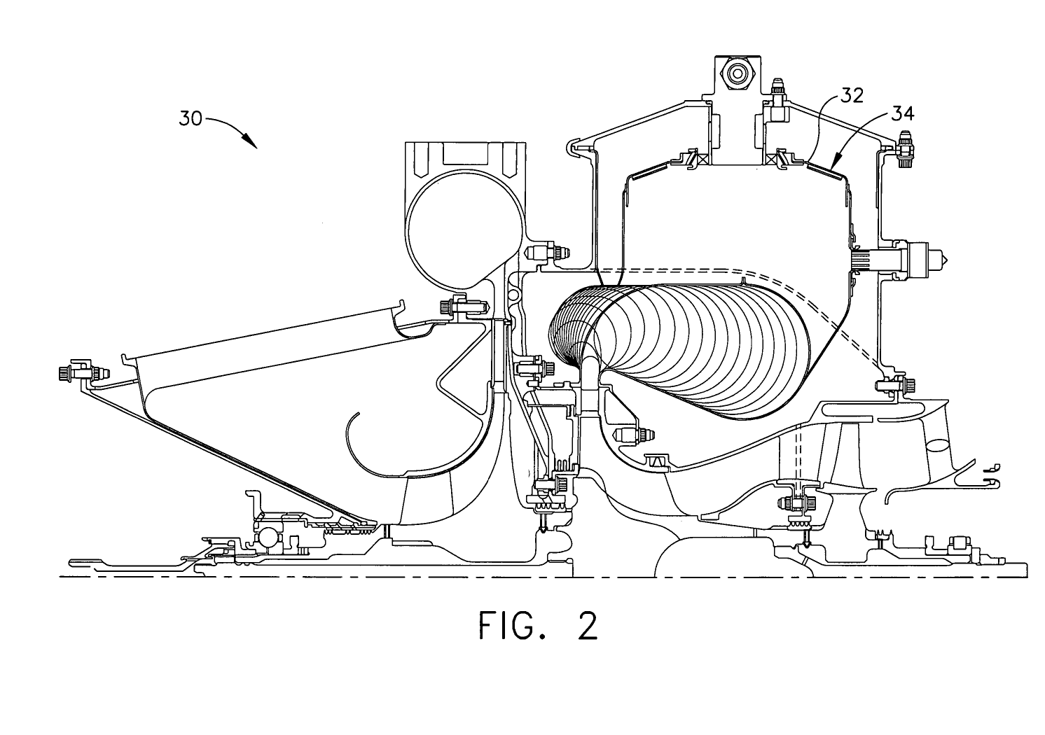

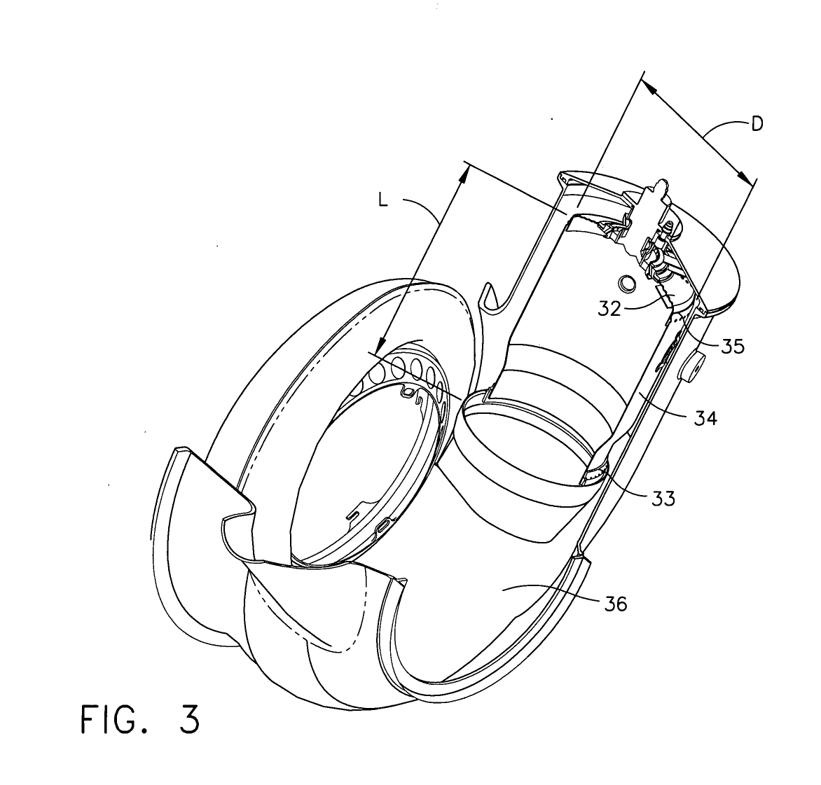

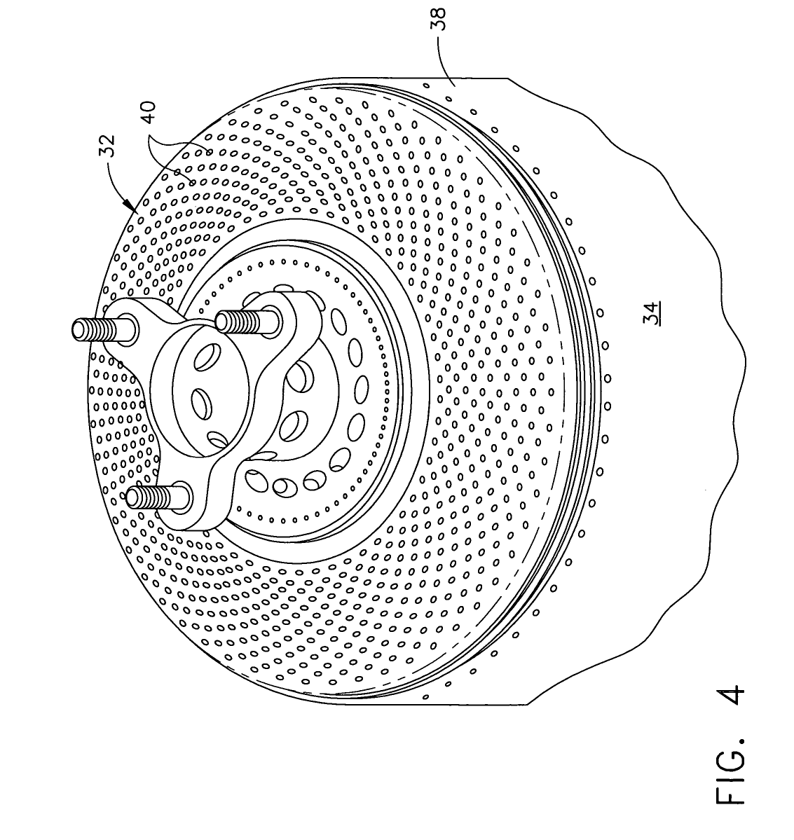

Referring to FIG. 2, there is shown a cross-sectional view of the power section of a high-performance engine 30 which may have a dome 32 and a combustion chamber 34 according to the cooling design of the present invention. Referring also to FIG. 3, there is shown a partially cut-away perspective view of the combustion chamber 34 and scroll assembly 36 which may have the dome 32 and combustion chamber 34 cooling design according to the present invention. High performance engines, such as those used on various Joint Strike Fighter (JSF) aircraft, may have very stringent life requirements. The thermal and mechanical stress on the combustion chamber 34 should be minimized to meet a life requirement of at least 10,000 cycles. Conventional louvers 18, 18a (see FIG. 1) may not uniformly and adequately cool the combustion chamber 34 of the present invention, as shown in more detail below with reference to FIG. 4.

The design of the combustion chamber 34 of the present invention may be used to maximize the volume of the combustion chamber 34 within a limited installation envelope, as may be found on many modern aircraft. Combustion chamber 34 may have a first end 33 attached to the scroll assembly 36 and a second end 35 attached to the dome 32. The length L of the combustion chamber 34 may be defined as the distance from the first end 33 to the second end 35. In one embodiment of the present invention, for example, with reference to FIG. 3, the ratio of the length L of combustion chamber 34 to the diameter D of dome 32 may be greater than or equal to about 2, and typically the ratio may be between about 2 and about 3. For a given installation envelope, the length L may be increased by using a relatively flat dome 32 (as compared to conventional domes), thereby allowing increased installation envelope space for the length L of combustion chamber 34.

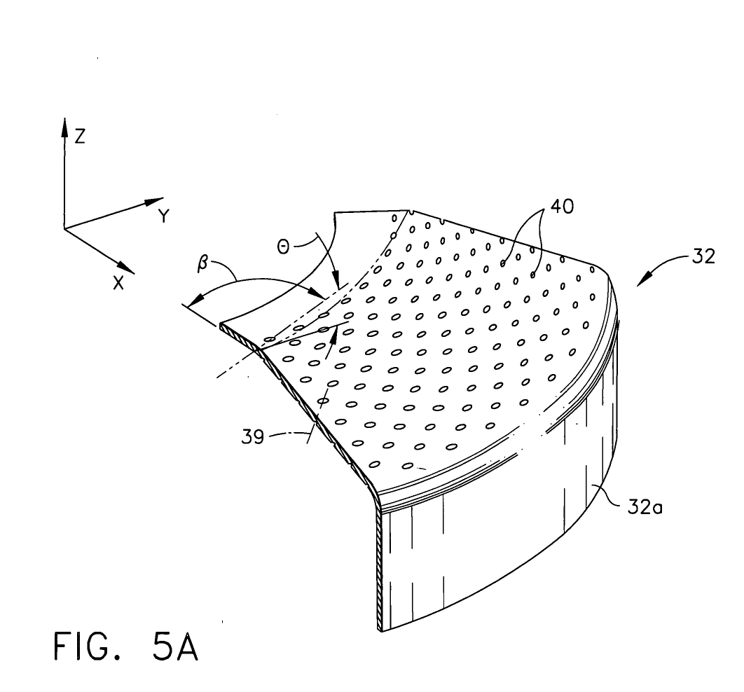

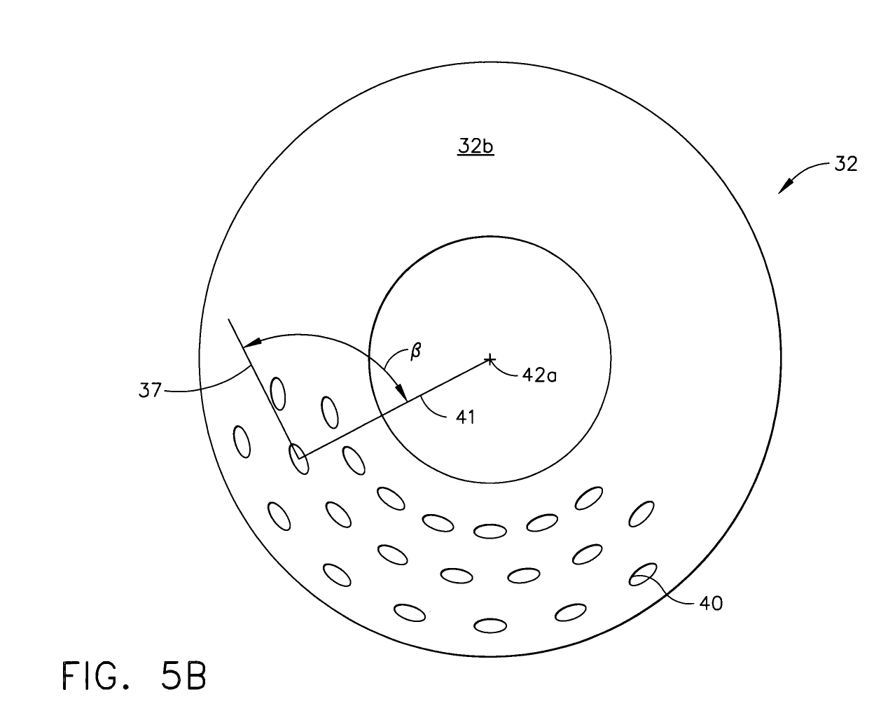

Referring now to FIGS. 4 and 5, there are shown a perspective view and a close-up view thereof, of dome 32 for combustion chamber 34 of the present invention. A can combustion liner 38 may be fabricated by typical forming methods using thin sheet metal, wherein the sheet metal has a thickness typically from about 0.015 to about 0.063 inch, more typically from about 0.017 to about 0.032 inch. A dome wall 32a of dome 32 may be brazed and/or welded to combustion chamber 34.

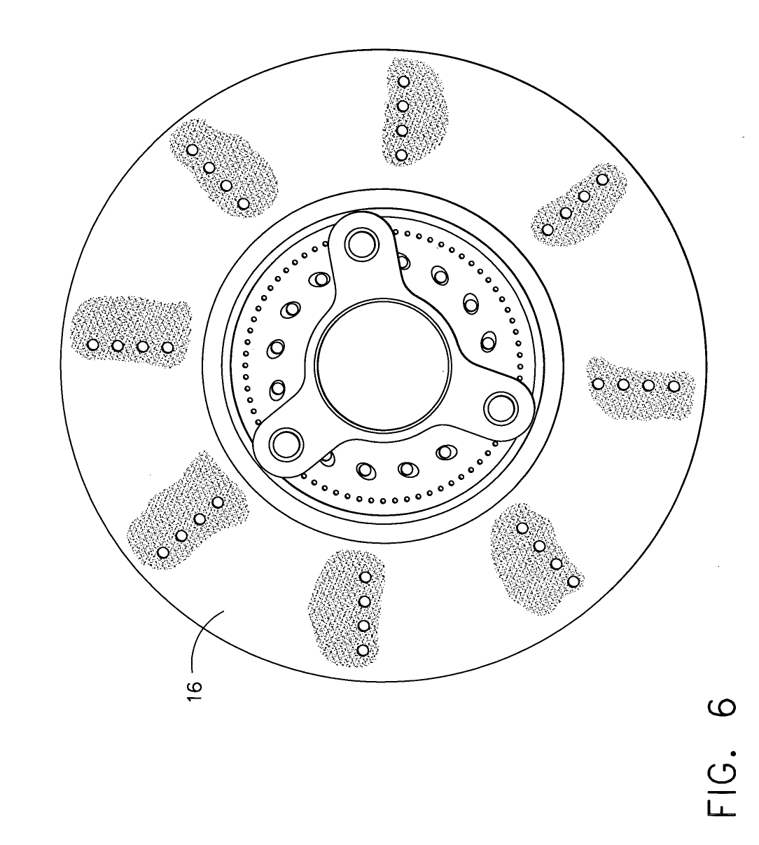

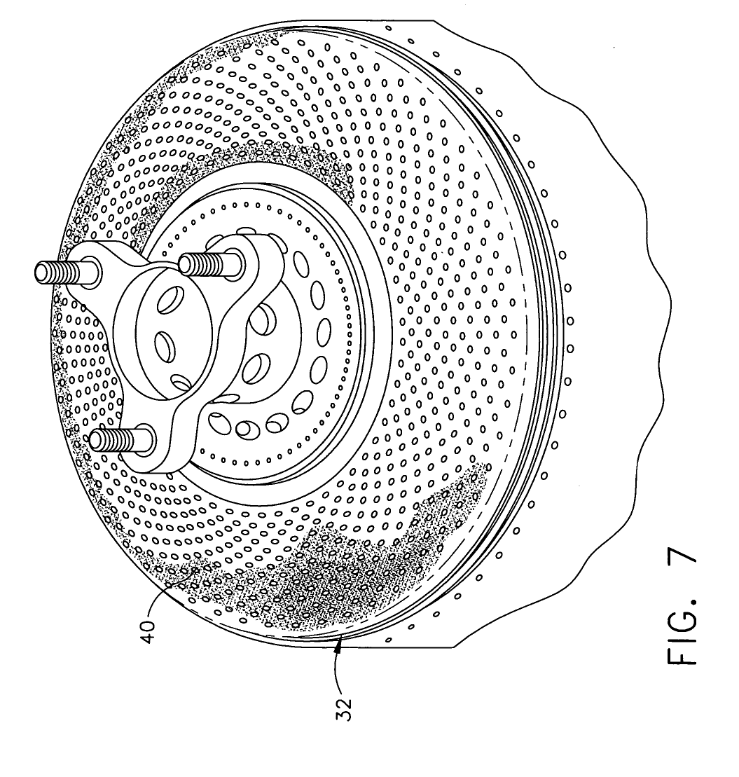

Effusion holes 40 may be created in dome 32 by using various processes, such as a laser drilling operation. Effusion holes 40 allow a cooling air flow to enter the combustion chamber 34. The density of the effusion holes 40 and the size of the effusion holes 40 may vary, for example, according to the operating temperatures of engine 30 and the amount of cooling that is needed, for example, to maintain a particular operating temperature. Typically, there may be from about 10 to about 100 effusion holes 40 per square inch of surface area of dome 32. An exemplary density of effusion holes may be from about 10 to about 100 effusion holes 40 per square inch of surface area of dome 32. Typically, the effusion holes 40 are uniformly spaced on dome 32, as shown in FIGS. 4 and 5, however, any spacing may be used, so long as efficient cooling is imparted to dome 32 and combustion chamber 34. Typically, the effusion holes 40 are round in cross-section, however, other shapes may be useful in the design and method of the present invention. For example, the effusion holes 40 may be oval, egg-shaped or tapered. Typically, the diameter of effusion holes 40 may vary from about 0.010 to about 0.040 inch, and more typically from about 0.020 to about 0.030 inch. As discussed previously, the shape, size, spacing and density of effusion holes 40 may vary so long as adequate cooling of dome 32 is maintained during engine operation. Adequate cooling may be exemplified by cooling to provide a temperature variation of less than about 500° F., more typically less than about 250° F. An example of adequate cooling may be shown in reference to FIGS. 6 and 7, as further discussed below.

Referring specifically to FIGS. 5A and 5B, the orientation of effusion holes 40 may cool the dome 32 and reduce the formation of carbon. For a given effusion hole 40, the angle α may be defined, as shown, to be the angle between a center axis 39 of the effusion hole 40 and a tangent to the surface of dome 32 at the point of the effusion hole 40. Angle θ may be described as being formed in the y-z plane as shown in FIG. 5A. Angle θ may vary from about 7 to about 90 degrees, as an example. In one embodiment of the present invention, angle θ may vary from about 12 to about 45 degrees, typically from about 17 to about 23 degrees. The angle β may be defined, as further shown in FIG. 5B, as the angle formed in the plane of the surface 32b of dome 32 between a first line 41, connecting the center 42a of combustion chamber 34 with the effusion hole 40, and a second line 37, being the center axis 39 of the effusion hole 40 projected onto the surface 32b of dome 32. Angle β may be described as being formed in the x-y plane as shown in FIG. 5A. Angle β may vary from about 0 to about 180 degrees, typically from about 80 to about 100 degrees. In one embodiment of the present invention, the effusion holes 40 are formed over the entire surface of dome 32 and each hole 40 shares the same vectors (angles θ and β), thereby facilitating the air to whirl about the centerline 42 as well as creating a gaseous film along the inner surface of the dome 32.

### EXAMPLE

Referring now to FIGS. 6 and 7, there are shown thermal paint results on a conventional dome 16 of a prior art combustion chamber cooling design, and thermal paint results on the dome 32 and combustion chamber cooling design according to the present invention, respectively. The dome 32 of the present invention was formed having 62 effusion holes/in², as shown in FIG. 7. The conventional dome 16 was formed using conventional technology as shown in FIG. 6. A conventional thermal paint test was conducted while the domes 16, 32 were used during operation of a high performance engine.

The effusion cooling design of the dome 32 according to the present invention resulted in a considerable improvement in that it provided a lower surface temperature and a more uniform surface temperature distribution. The dome 32 of the present invention gave an average surface temperature of about 1100° F., with a temperature variation of about ±100° F. On the other hand, the conventional dome 16, when used in the same operating environment, gave a non-uniform temperature distribution varying from 540° F. to 1300° F.

Improving the temperature distribution may allow the combustion system to meet a life requirement of at least 10,000 cycles. Furthermore, the design of the present invention reduces the risk of potential carbon formation by eliminating the louvers and flow steps caused by the louvers. To this end, the present invention therefore reduces the risk of carbon deposition on the louvers that may separate and be ingested downstream, thus enhancing the system reliability and durability. The design of the present invention also may reduce manufacturing cost and weight by eliminating the louvers in the combustor dome. The uniform cooling results achieved with the design of the present invention may also reduce, or eliminate, the need for a thermal barrier coating on dome 32, whereas in conventional systems a thermal barrier coating may be required. Further, the design of the present invention allows dome 32 to have a relatively low profile, as compared with conventional dome design, thereby allowing for installation of an engine comprising dome 32 in smaller installation envelopes, for example, in aircraft.

The present invention also relates to a method for uniformly cooling the dome 32 of the combustion chamber 34 of a gas turbine engine, e.g., engine 30. The method may include a step of providing the dome 32, which may include a dome wall 32a having a plurality of effusion holes 40 therethrough. The effusion holes 40 formed by the cutting step may be uniformly spaced on the surface of the dome 32. The effusion holes 40 may be formed by a process such as laser drilling. The effusion holes 40 may have a size, shape, and orientation with respect to the dome surface as described hereinabove. Typically, the effusion holes 40 are cut having a density from about 10 to about 100 holes per square inch of the surface of dome 32. During operation of the engine, air may be passed through the effusion holes 40 into the combustion chamber 34, thereby providing uniform cooling of the dome 32.

It should be understood, of course, that the foregoing relates to exemplary embodiments of the invention and that modifications may be made without departing from the spirit and scope of the invention as set forth in the following claims.

1. A dome of a combustion chamber of an engine comprising:
a dome wall having a plurality of effusion holes passing through the dome wall, the effusion holes being uniformly spaced on the surface of the dome, wherein the effusion holes have a density of from about 10 to about 100 holes per square inch of the surface of the dome.

2. The dome according to claim 1, wherein the effusion holes have a hole density from about 50 to about 70 holes per square inch of the surface of the dome.

3. The dome according to claim 1, wherein each of the effusion holes has a diameter of from about 0.010 to about 0.040 inch.

4. The dome according to claim 3, wherein each of the effusion holes has a diameter of from about 0.020 to about 0.030 inch.

5. The dome according to claim 1, wherein a center axis of each of the effusion holes forms a first angle, E, with a tangent to the surface of the dome of from about 7 to about 90 degrees.

6. The dome according to claim 5, wherein the first angle is from about 17 to about 23 degrees.

7. The dome according to claim 1, wherein a centerline of the combustion chamber forms a second angle, β, with the center axis of each effusion hole of from about 0 to about 180 degrees.

8. The dome according to claim 7, wherein the second angle is from about 80 to about 100 degrees.

9. The dome according to claim 1, wherein a ratio of the length of the combustion chamber to the diameter of the dome is greater than or equal to about 2.

10. The dome according to claim 1, wherein a spatial temperature variation of no more than about 250° F. is observed for the dome during operation of the combustion chamber.

11. The dome according to claim 1, wherein the dome is used without any thermal barrier coating present thereon.

12. A dome for a combustion chamber of an engine comprising:
a dome wall having a plurality of effusion holes passing through the dome, the effusion holes being uniformly spaced on a surface of the dome with a hole density of from about 10 to about 100 holes per square inch, wherein
the effusion holes have a diameter from about 0.010 to about 0.040 inch;
a center axis of each the plurality of effusion holes forms a first angle with a tangent to the surface of the dome of from about 7 to about 90 degrees;
a centerline of the combustion chamber forms a second angle with the center axis of each of the plurality of effusion holes of from about 0 to about 180 degrees; and
a ratio of the length of the combustion chamber to the diameter of the dome is greater than or equal to about 2.

13. The dome according to claim 12, wherein the effusion holes have a hole density from about 50 to about 70 holes per square inch.

14. The dome according to claim 12, wherein each of the effusion holes has a diameter from about 0.020 to about 0.030 inch.

15. The dome according to claim 12, wherein the first angle is from about 17 to about 23 degrees.

16. The dome according to claim 12, wherein the second angle is from about 80 to about 100 degrees.

17. The dome according to claim 12, wherein a temperature variation of no more than about 250° F. is observed for the dome during operation of the engine.

18. The dome according to claim 12, wherein the dome is used without any thermal barrier coating present thereon.

19. A combustion chamber for an engine comprising:
a dome;
a can combustion liner having a first end attached to a scroll assembly, and a second end covered by the dome; and
a plurality of effusion holes passing through the dome, the effusion holes being uniformly spaced on a surface of the dome with a density of from about 10 to about 100 holes per square inch of the surface of the dome.

20. The dome according to claim 19, wherein the effusion holes are uniformly spaced on the surface of the dome with the density being from about 50 to about 70 holes per square inch.

21. The dome according to claim 19, wherein the effusion holes have a diameter of from about 0.020 to about 0.030 inch.

22. The dome according to claim 19, wherein a center axis of each of the plurality of effusion holes forms an angle with the surface of the dome of from about 17 to about 23 degrees.

23. The dome according to claim 19, wherein a centerline of the combustion chamber forms a second angle with the center axis of each of the plurality of effusion hole of from about 80 to about 100 degrees.

24. The dome according to claim 19, wherein a ratio of the length of the combustion chamber to the diameter of the dome is greater than or equal to about 2.

25. The dome according to claim 19, wherein a temperature variation of not more than about 250° F. is observed for the dome during operation of the engine.

26. A combustion chamber for an aircraft engine comprising:
a dome;
a can combustion liner having a first end attached to a scroll and a second end covered by the dome; and
a dome wall having a plurality of effusion holes passing through the dome wall, the effusion holes being uniformly spaced on the dome with a density from about 10 to about 100 holes per square inch of the surface of the dome, wherein
each of the plurality of effusion holes has a diameter from about 0.010 to about 0.040 inch;
a center axis of each the plurality of effusion holes forms a first angle, θ, with the surface of the chamber dome of from about 7 to about 90 degrees;
a centerline of the combustion chamber forms a second angle, β, with the center axis of each of the plurality of effusion holes of from about 0 to about 180 degrees; and
a ratio of the length of the combustion chamber to the diameter of the dome is greater than or equal to about 2.

27. The dome according to claim 26, wherein:
the effusion holes are uniformly spaced on a surface of the dome with a hole density from about 50 to about 70 holes per square inch; and
the effusion holes have a diameter from about 0.020 to about 0.030 inch.

28. The dome according to claim 26, wherein:
the first angle is from about 17 to about 23 degrees; and
the second angle is from about 80 to about 100 degrees.

29. A high performance gas turbine engine comprising:
a combustion chamber;
a dome attached to a first end of the combustion chamber;
a scroll assembly attached to a second end of the combustion chamber; and
a plurality of effusion holes passing through the dome, the effusion holes being uniformly spaced about the dome with a hole density from about 10 to about 100 holes per square inch, wherein
each of the effusion holes has a diameter from about 0.010 to about 0.040 inch;
a center axis of each the plurality of effusion holes forms a first angle with the surface of the chamber dome of from about 7 to about 90 degrees;
a centerline of the combustion chamber forms a second angle with the center axis of each of the plurality of effusion holes of from about 0 to about 180 degrees; and
a ratio of the length of the combustion chamber to the diameter of the dome is greater than or equal to about 2.

30. The engine according to claim 29, wherein:
the effusion holes are uniformly spaced on the dome with a density from about 50 to about 70 holes per square inch of the surface of the dome;
each of the effusion holes have a diameter from about 0.020 to about 0.030 inch;
the first angle is from about 17 to about 23 degrees; and
the second angle is from about 80 to about 100 degrees.

31. A method for uniformly cooling a dome of a combustion chamber of an engine, comprising:
a) providing the dome, the dome including a dome wall having a plurality of effusion holes therethrough, the effusion holes being uniformly spaced on a surface of the dome with a hole density from about 10 to about 100 holes per square inch; and
b) passing an airflow through the effusion holes into the combustion chamber during operation of the engine.

32. The method according to claim 31, wherein:
the effusion holes have a diameter from about 0.010 to about 0.040 inch;
a center axis of each the plurality of effusion holes forms a first angle with the surface of the dome of from about 7 to about 90 degrees; and
a centerline of the combustion chamber forms a second angle with the center axis of each of the plurality of effusion holes of from about 0 to about 180 degrees.

33. The method according to claim 31, wherein:
a ratio of the length of the combustion chamber to the diameter of the combustion chamber is greater than or equal to about 2.

34. The method according to claim 31, wherein:
the effusion holes are uniformly spaced about the dome with a density from about 50 to about 70 holes per square inch; and the effusion holes have a diameter from about 0.020 to about 0.030 inch.

35. The method according to claim 31, wherein:
the first angle is from about 17 to about 23 degrees; and
the second angle is from about 80 to about 100 degrees.

36. The method according to claim 31, wherein the step of cutting the plurality of effusion holes through the dome is preformed by laser drilling the dome.

37. The method according to claim 31, wherein the dome lacks a thermal barrier coating during said steps a) and b).
